(19) United States
(12) Patent Application Publication
(10) Pub. No.: US 2012/0209825 A1
(43) Pub. Date: Aug. 16, 2012

(54) PERSONAL INFORMATION MANAGEMENT SYSTEM

(76) Inventor: Hironori SUGAWARA, Sendai-shi (JP)

(21) Appl. No.: 13/354,840

(22) Filed: Jan. 20, 2012

(30) Foreign Application Priority Data
Feb. 13, 2011 (JP) 2011-028018

(51) Int. Cl. G06F 17/30

(52) U.S. Cl. 707/705; 707/E17.005

(57) ABSTRACT

A personal information management system includes a user-information reception unit that receives an input of user information by a user; a user's-acquaintances-information reception unit that receives an input of user's acquaintances information by the user; a death news reception unit that receives an input of death news information; a user-information storage unit that stores the user information; and a user's-acquaintances-information storage unit that stores the user's acquaintances information. The user's acquaintances information contains disclosure permission information that defines whether the user information and/or the user's acquaintances information are/is disclosed when the user has passed away. The personal information management system further includes an access enabling unit that enables, when the death news reception unit receives the death news information, relatives and acquaintances of the user to access to the user information and/or the user's acquaintances information according to details defined in the disclosure permission information.

### BACKGROUND OF THE INVENTION

1. Field of the Invention

The present invention relates to a system that enables person-related information stored before death of a person to be made open to relatives and acquaintances after the person has passed away.

2. Description of the Related Art

Recently, ending notes (i.e., written wills) are being introduced. The ending notes are notes in which persons write down wish items in advance on the assumption that they would pass away or be confined to their bed for a long time. Here, the wish items include wishes for caring and a funeral ceremony, necessity or unnecessity of a life-prolonging device, or the like.

On the other hand, Patent Documents 1 through 4 and the like have proposed the technologies of providing information on the deceased.

Patent Document 1: JP-A-2002-73847

Patent Document 2: JP-A-2009-32220

Patent Document 3: JP-A-2010-257410

Patent Document 4: JP-A-2010-282595

However, the above technologies have a problem in that the deceased cannot record information on himself or herself and information on relatives and acquaintances before his or her death and convey information recorded by the deceased to persons within a desired limited range using his or her death as a trigger.

### SUMMARY OF THE INVENTION

In view of the above drawback, the present invention has an object of providing a personal information management system, a personal information management method, and a personal information management program that enable the deceased to record information on himself or herself and information on relatives and acquaintances before his or her death and convey the information recorded by the deceased to persons within a desired limited range using his or her death as a trigger.

An embodiment of a disclosed personal information management system includes a user-information reception unit configured to receive an input of user information by a user, the user information containing personal-history information as information on events related to the user and future action plans and containing possession-assets information as information on assets possessed by the user; a user's-acquaintances-information reception unit configured to receive an input of user's acquaintances information by the user, the user's acquaintances information containing personal information on relatives and acquaintances of the user; a death news reception unit configured to receive an input of death news information as information indicating that the user has passed away; a user-information storage unit configured to store the user information received by the user-information reception unit; and a user's-acquaintances-information storage unit configured to store the user's acquaintances information received by the user's-acquaintances-information reception unit. The user's acquaintances information contains disclosure permission information that defines for each of the relatives and the acquaintances of the user whether the user information stored in the user-information storage unit and/or the user's acquaintances information stored in the user's-acquaintances-information storage unit are/is disclosed when the user has passed away. The personal information management system further comprises an access enabling unit configured to enable, when the death news reception unit receives the death news information, the relatives and the acquaintances of the user to which the user information and/or the user's acquaintances information are/is defined by the disclosure permission information to be disclosed when the user has passed away to access to the user information stored in the user-information storage unit and/or the user's acquaintances information stored in the user's-acquaintances-information storage unit according to details defined in the disclosure permission information.

A disclosed personal information management system enables the deceased to record information on himself or herself and information on relatives and acquaintances before his or her death and convey the information recorded by the deceased to persons within a desired limited range using his or her death as a trigger.

Other objects, features and advantages of the present invention will become more apparent from the following detailed description when read in conjunction with the accompanying drawings.

### BRIEF DESCRIPTION OF THE DRAWINGS

FIG. 1 is a view for explaining a general outline of a personal information management system according to this embodiment;

FIG. 2 is a function block diagram of the personal information management system according to this embodiment;

FIG. 3 is a diagram illustrating an example of items contained in personal-history information according to this embodiment;

FIG. 4 is a diagram illustrating an example of items contained in the personal-history information according to this embodiment;

FIG. 5 is a diagram illustrating an example of items contained in the personal-history information according to this embodiment;

FIG. 6 is a diagram illustrating an example of items contained in possession-assets information according to this embodiment;

FIG. 7 is a diagram illustrating an example of items contained in user's acquaintances information according to this embodiment;

FIG. 8 is a diagram illustrating an example of the hardware configuration of the personal information management system according to this embodiment;

FIG. 9 is a flowchart illustrating an example of processing by the personal information management system according to this embodiment;

FIG. 10 is a diagram illustrating an example of a screen by the personal information management system according to this embodiment;

FIG. 11 is a diagram illustrating an example of a screen for inputting the user's acquaintances information according to this embodiment;

FIG. 12 is a diagram illustrating an example of a screen for inputting message information according to this embodiment; and

FIG. 13 is a diagram illustrating an example of a screen displayed by a personal-history display unit according to this embodiment.

### DETAILED DESCRIPTION OF THE PREFERRED EMBODIMENTS

An embodiment for carrying out the present invention is described with reference to the accompanying drawings.

(Operational Principle of Personal Information Management System According to This Embodiment)

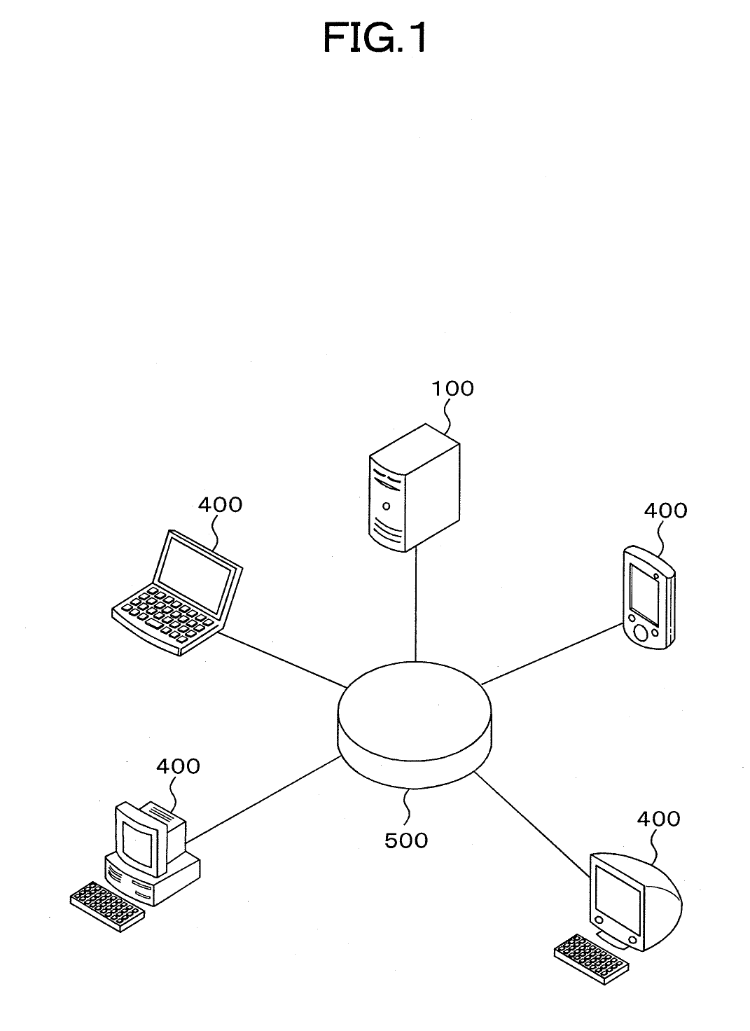

A general outline of a personal information management system 100 according to this embodiment is described with reference to FIG. 1. FIG. 1 is a view for explaining the general outline of the personal information management system 100. The personal information management system 100 is connected to user terminals 400 via a communications network 500 such as the Internet. Users can access to the personal information management system 100 from the respective user terminals 400 via the communications network 500 and enjoy services offered by the personal information management system 100. Here, the user terminals 400 are information processing apparatuses such as mobile phones, smart phones, notebook-sized personal computers, and desktop personal computers, and can be in any form so long as they are capable of being connected to the personal information management system 100 via the communications network 500.

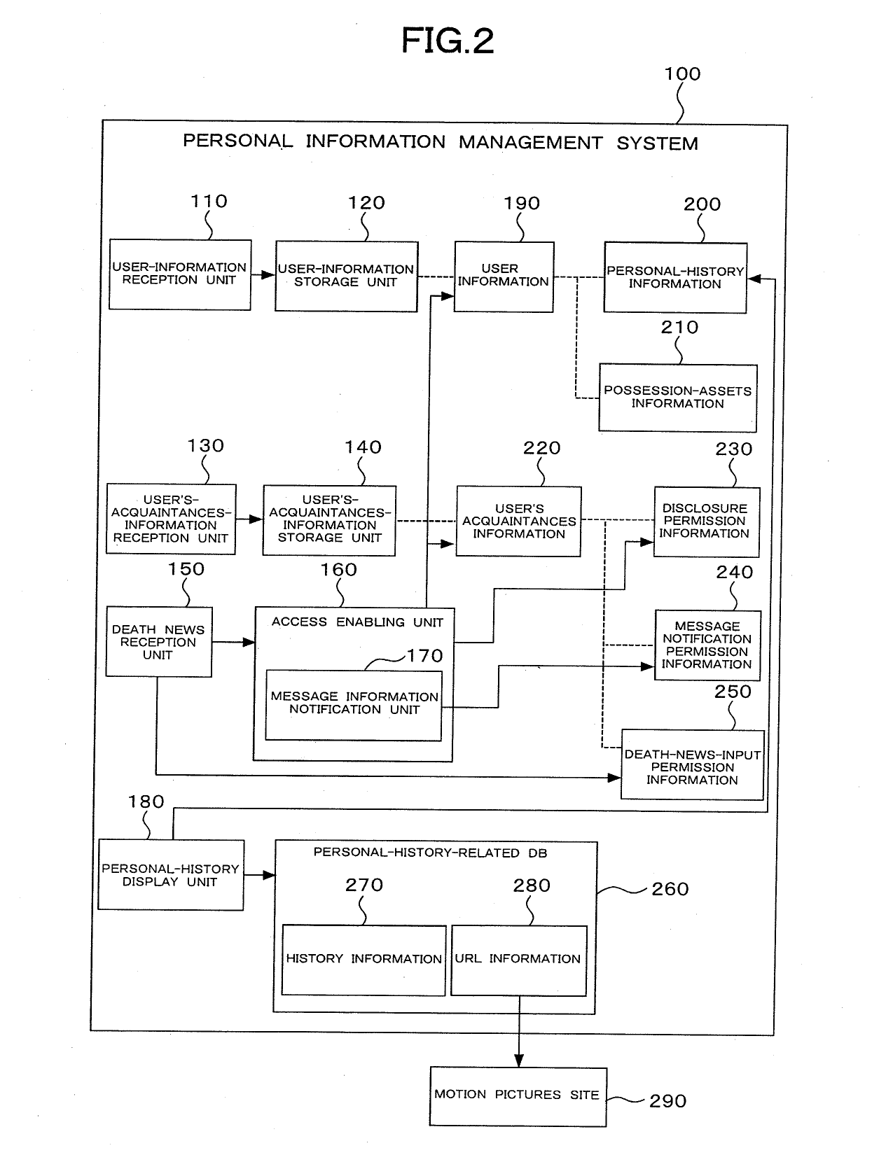

The operational principle of the personal information management system 100 is described with reference to FIG. 2. FIG. 2 is a function block diagram of the personal information management system 100. As illustrated in FIG. 2, the personal information management system 100 has a user-information reception unit 110, a user-information storage unit 120, a user's-acquaintances-information reception unit 130, a user's-acquaintances-information storage unit 140, a death news reception unit 150, an access enabling unit 160, a message information notification unit 170, a personal-history display unit 180, and a personal-history-related database (hereinafter referred to as a “personal-history-related DB”) 260.

The user-information reception unit 110 receives an input by the user via the user terminal 400, i.e., the input of personal-history information 200 as information on the attributes of the user, past events taken place around the user, future action plans pictured by the user, or the like.

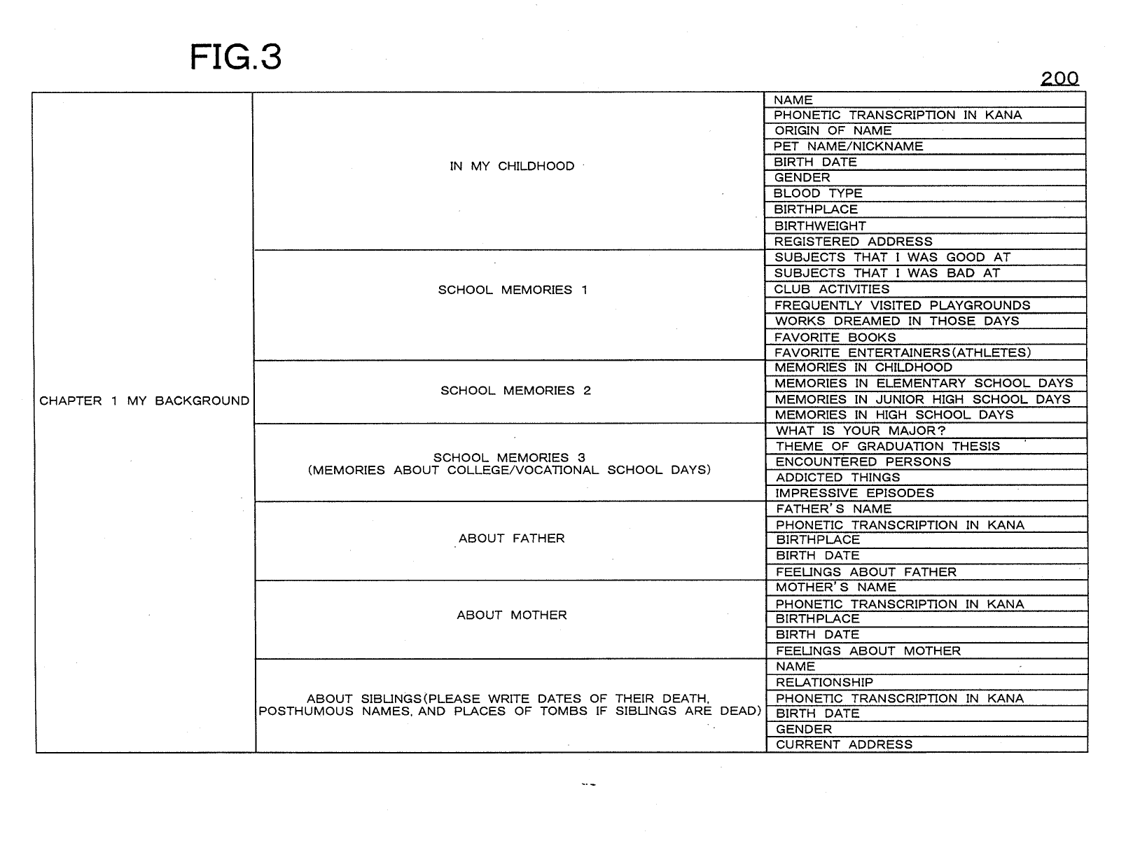

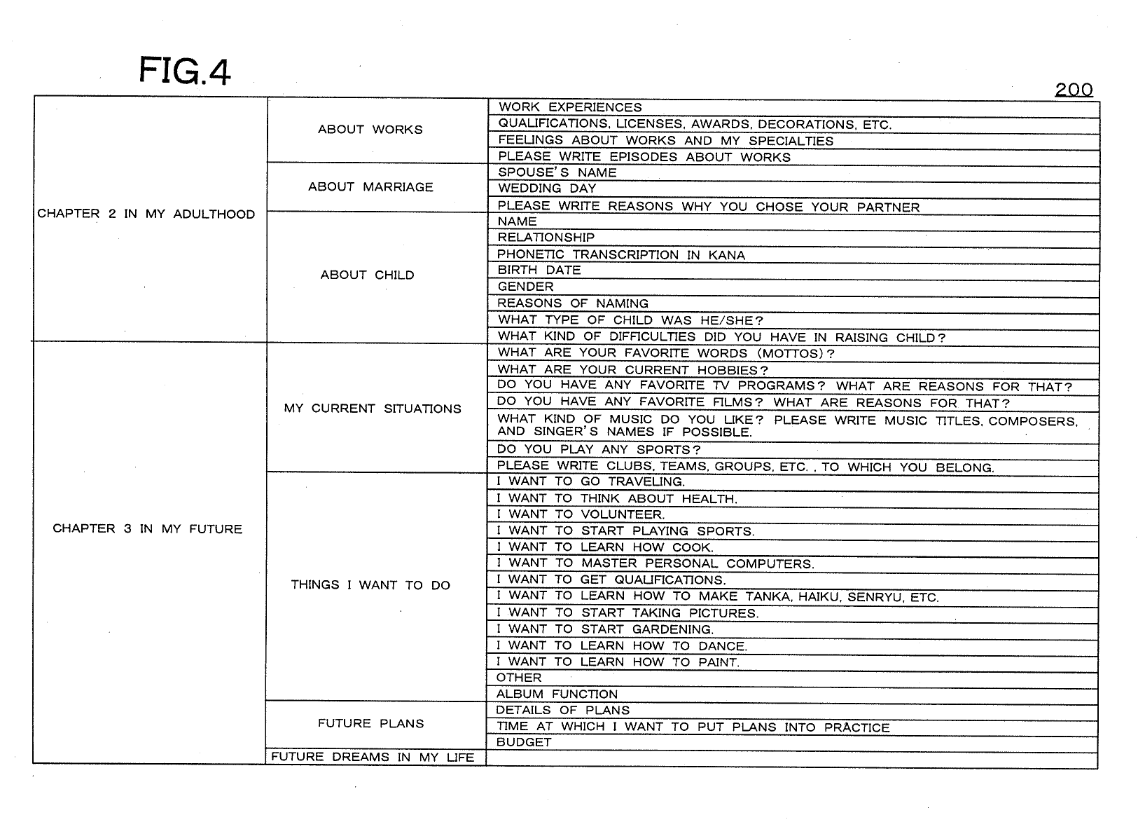

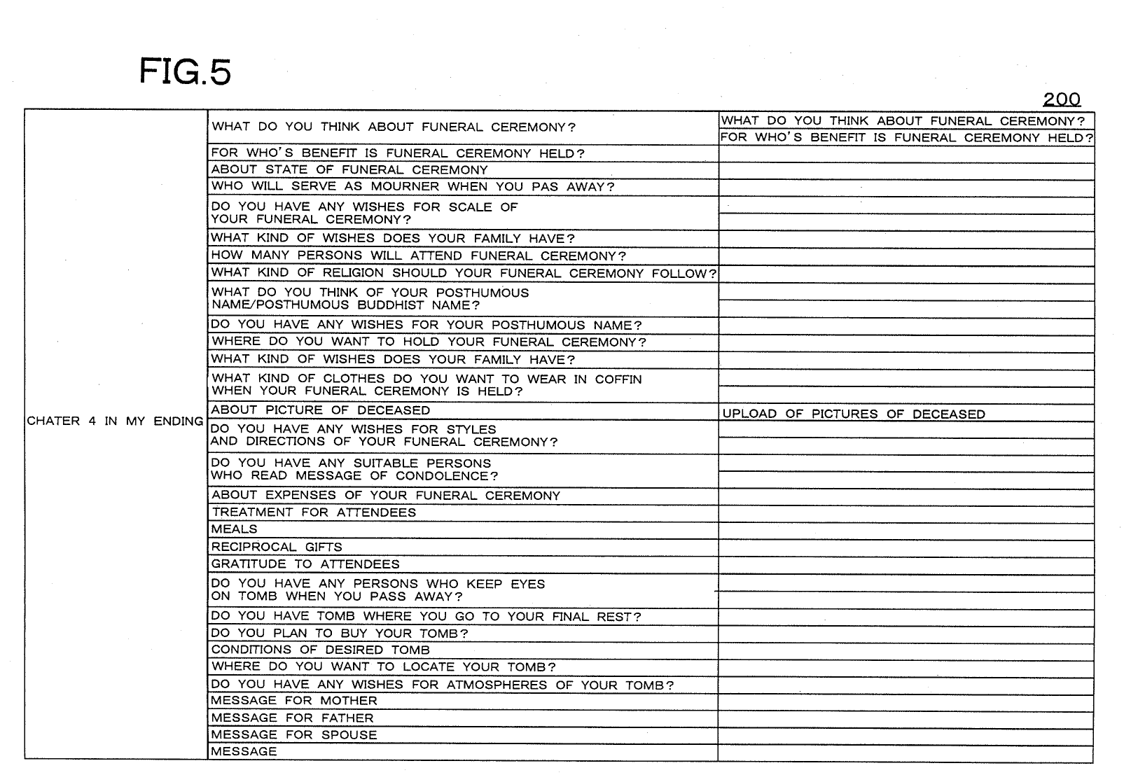

FIGS. 3 through 5 illustrate an example of the personal-history information 200. As illustrated in FIG. 3, the personal-history information 200 contains information in user's childhood such as the name of the user (accompanied with a phonetic transcription in kana), the origin of the name, a user's pet name or nickname, a birth date, a gender, a blood type, a birthplace, and a birthweight. Further, as illustrated in FIGS. 3 and 4, the personal-history information 200 contains memories about user's school days, information on a father, a mother, and siblings, and information on works, a marriage, and a child. Further, as illustrated in FIGS. 4 and 5, the personal-history information 200 contains information on future action plans, details of a desired funeral ceremony, and the like. The personal-history information 200 is so-called an ending note.

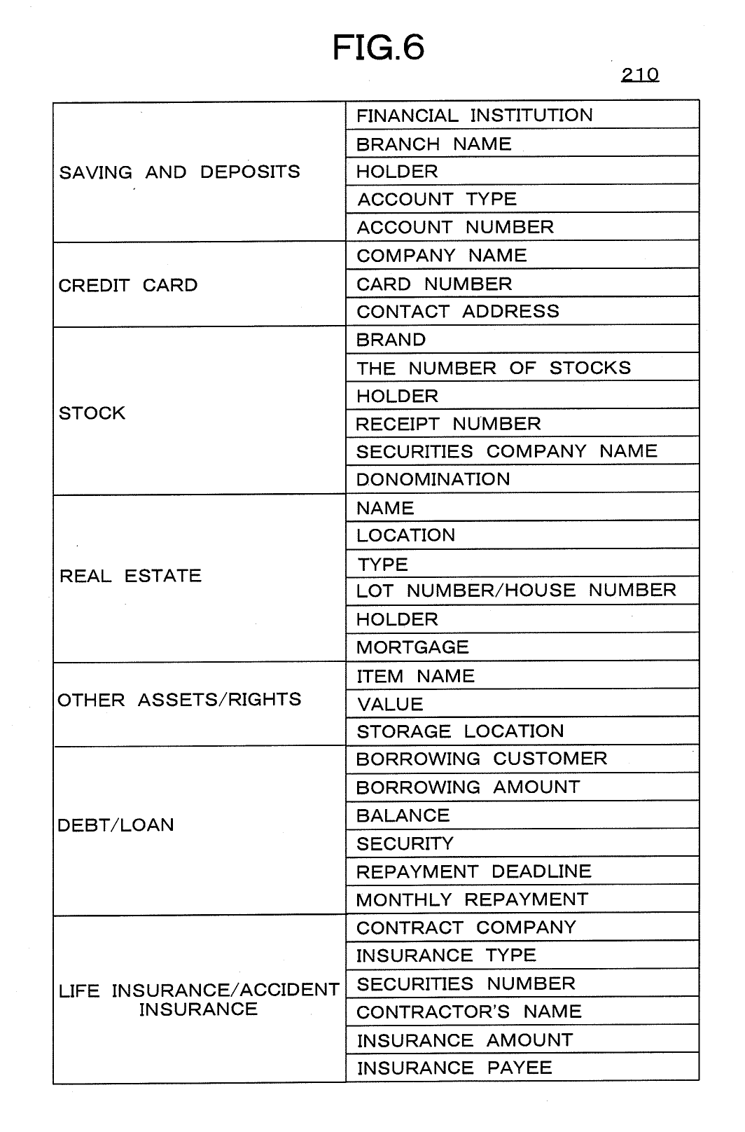

Further, the user-information reception unit 110 receives an input by the user via the user terminal 400, i.e., the input of possession-assets information 210 as information on assets possessed by the user. FIG. 6 illustrates an example of the possession-assets information 210. As illustrated in FIG. 6, the possession-assets information 210 contains information on user's deposits and savings (such as a correspondent financial institution, a branch name, a holder, an account type, and an account number), a credit card, a stock, a real estate, other assets and rights, a debt, a life insurance, and an accident insurance.

The user-information storage unit 120 stores user information 190 as personal information on the user containing the personal-history information 200 and the possession-assets information 210. The user-information storage unit 120 is, for example, an auxiliary storage unit such as a hard disk drive.

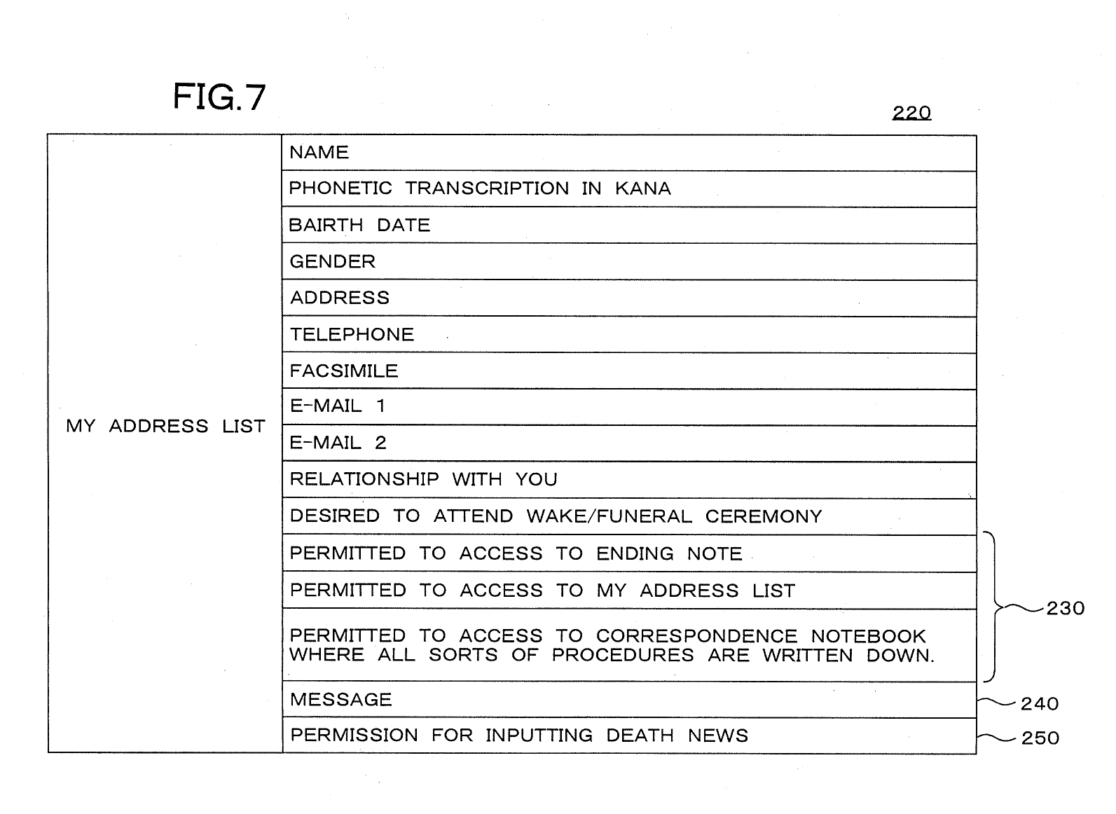

The user's-acquaintances-information reception unit 130 receives an input by the user via the user terminal 400, i.e., the input of user's acquaintances information 220 as personal information on relatives and acquaintances of the user. FIG. 7 illustrates an example of the user's acquaintances information 220. For example, as illustrated in FIG. 7, the user's acquaintances information 220 contains personal information on a relative or an acquaintance of the user, such as the name of the relative or the acquaintance of the user (accompanied with a phonetic transcription in kana), a birth date, a gender, an address, a telephone number, a facsimile number, E-mail addresses, and a relationship with the user.

Further, as illustrated in FIG. 7, the user's acquaintances information 220 contains information that defines for each of the relatives and the acquaintances “whether each of the relatives and the acquaintances is desired to attend a user's wake and a funeral ceremony,” “whether each of the relatives and the acquaintances is permitted to access to the personal-history information 200 when the user has passed away” (hereinafter referred to as “disclosure permission information”) 230, “whether each of the relatives and the acquaintances is permitted to access to the user's acquaintances information 220 when the user has passed away” (hereinafter referred to as the “disclosure permission information”) 230, “whether each of the relatives and the acquaintances is permitted to access to the possession-assets information 210 when the user has passed away” (hereinafter referred to as the “disclosure permission information”) 230, “whether each of the relatives and the acquaintances is permitted to be notified of a message when the user has passed away” (hereinafter referred to as “message notification permission information”) 240, “whether each of the relatives and the acquaintances is permitted to input death news information when the user has passed away” (hereinafter referred to as “death-news-input permission information”) 250, and the like. It is to be noted that the message notification permission information also contains the message to be notified to each of the relatives and the acquaintances.

The user's-acquaintances-information storage unit 140 stores the user's acquaintances information 220. The user's-acquaintances-information storage unit 140 is, for example, an auxiliary storage unit such as a hard disk drive.

The death news reception unit 150 receives an input by the user via the user terminal 400, i.e., the input of death news information as information indicating that the user has passed away. As a matter of course, the user who inputs the information received by the user-information reception unit 110 and the user's-acquaintances-information reception unit 130 is different from the user who inputs the death news information received by the death news reception unit 150. Further, the death news reception unit 150 determines whether the user who inputs the death news information is equivalent to the user who is permitted to input the death news information when the user has passed away, and then receives the input of the death news information only where the user is determined to be permitted to input the death news information. Here, the determination of the user who is permitted to input the death news information is performed based on typical user authentication processing.

The access enabling unit 160 enables, when the death news reception unit 150 receives the death news information, an access to the user information 190 and the user's acquaintances information 220 according to the details of the disclosure permission information 230 input by the user as a person concerned with the death news information. More specifically, the access enabling unit 160 determines according to the disclosure permission information 230 whether the user who wishes to access to the user information 190 and the user's acquaintances information 220 is equivalent to the user who is permitted to access to the user information 190 and the user's acquaintances information 220 when some user has passed away, and then enables the user to access to the user information 190 and the user's acquaintances information 220 only where the user is determined to be the user who is permitted to access to the user information 190 and the user's acquaintances information 220. Here, the determination of the user who is permitted to access to the user information 190 and the user's acquaintances information 220 is performed based on typical user authentication processing.

Further, the access enabling unit 160 has the message information notification unit 170. The message information notification unit 170 notifies, when the death news reception unit 150 receives the death news information, each of the relatives and the acquaintances of the user of a message according to the details of the message notification permission information 240 input by the user as a person concerned with the death news information. For example, the message information notification unit 170 sends the “message” to addresses written in the user's acquaintances information 220 by post or sends the “message” to E-mail addresses written in the user's acquaintances information 220 by e-mail.

The personal-history display unit 180 causes a user's personal history to be displayed on the display unit of the user terminal 400 based on the user information 190 and the personal-history-related DB 260. Here, the personal-history-related DB 260 is a database in which history information 270 as information on past events and URL (Uniform Resource Locator) information 280 on motion pictures describing the respective events in the history information 270 and posted to an outside motion-pictures posting site 290 are stored so as to be related to each other. For example, with respect to the user who wishes to make an access from the user terminal 400, the personal-history display unit 180 refers to information on a birth date written in the personal-history information 200 and then causes the history information 270 and the motion pictures specified by the URL information 280 related to the history information 270 to be chronologically displayed on the display unit of the user terminal 400 with a date going back to a certain period from the birth date set as a starting point. The motion-pictures posting site 290 is, for example, YouTube™ or the like. Further, as the URL information 280 in the personal-history-related DB 260, a plurality of URL information for backup may be prepared in consideration of a case where linked motion pictures are deleted. Moreover, the URL information 280 in the personal-history-related DB 260 may automatically prepare URL information on most frequently reproduced motion pictures from a related tag in a case where the backup motion pictures are also deleted.

(Example of Hardware Configuration of Personal Information Management System According to this Embodiment)

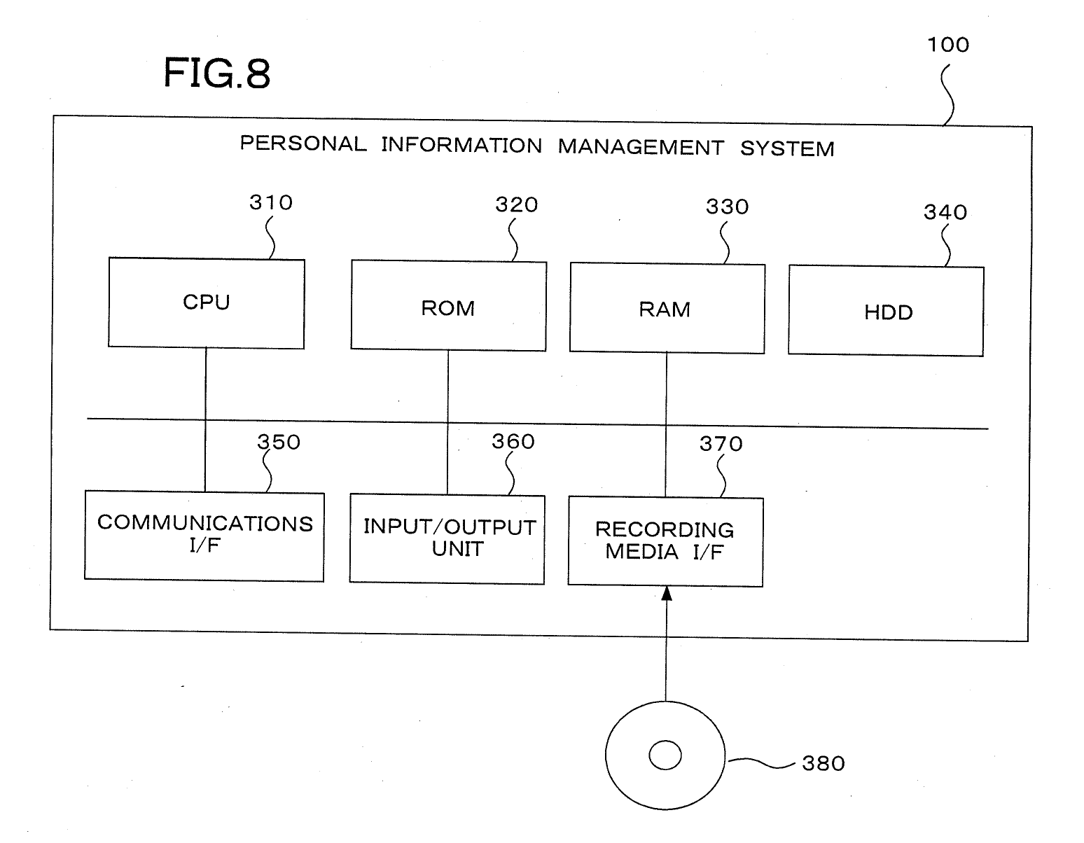

An example of the hardware configuration of the personal information management system 100 according to this embodiment is described with reference to FIG. 8. FIG. 8 is a diagram illustrating the example of the hardware configuration of the personal information management system 100.

As illustrated in FIG. 8, the personal information management system 100 has a CPU (Central Processing Unit) 310, a ROM (Read-Only Memory) 320, a RAM (Random Access Memory) 330, a HDD (Hard Disk Drive) 340, a communications interface (hereinafter referred to as a “communications I/F”) 350, an input/output unit 360, and a recording media interface (hereinafter referred to as a “recording media I/F”) 370.

The CPU 310 is a unit that executes a program stored in the ROM 320 and performs the calculation processing of data expanded (loaded) into the RAM 330 according to the instructions of the program to control the whole personal information management system 100. The ROM 320 stores the program and the data to be executed by the CPU 310. In the RAM 330, the program and the data are expanded (loaded) when the program stored in the ROM 320 is executed, and the calculation data is temporarily held during the calculation processing.

The HDD 340 is a unit that stores an OS (Operating system) as basic software and an application program or the like according to this embodiment together with related data. The HDD 340 includes, for example, the user-information storage unit 120 and the user's-acquaintances-information storage unit 140.

The communications I/F 350 is a unit that is connected to the communications network 500 such as the Internet and exchanges data with other apparatuses that provide a communications function. The input/output unit 360 includes an input device such as a keyboard for inputting data to the personal information management system 100, is composed of a LCD (Liquid Crystal Display) or the like, and includes an output device that serves as a user interface when the user uses the functions of the personal information management system 100 and performs various settings. The recording media I/F 370 is an interface for sending and receiving data to and from a recording medium 380 such as a CD-ROM, a DVD-ROM, and a USB memory.

Here, each of the units of the personal information management system 100 may be implemented in such a manner that the CPU 310 executes the program that is stored in the ROM 320 or the HDD 340 and corresponds to each of the units. Further, each of the units of the personal information management system 100 may implement processing related to each of the units as hardware. Further, a personal information management program according to the present invention may be read from the recording medium 380 via the recording media I/F 370 to cause the personal information management system 100 to execute the program.

(Flow of Processing by Personal Information Management System According to This Embodiment)

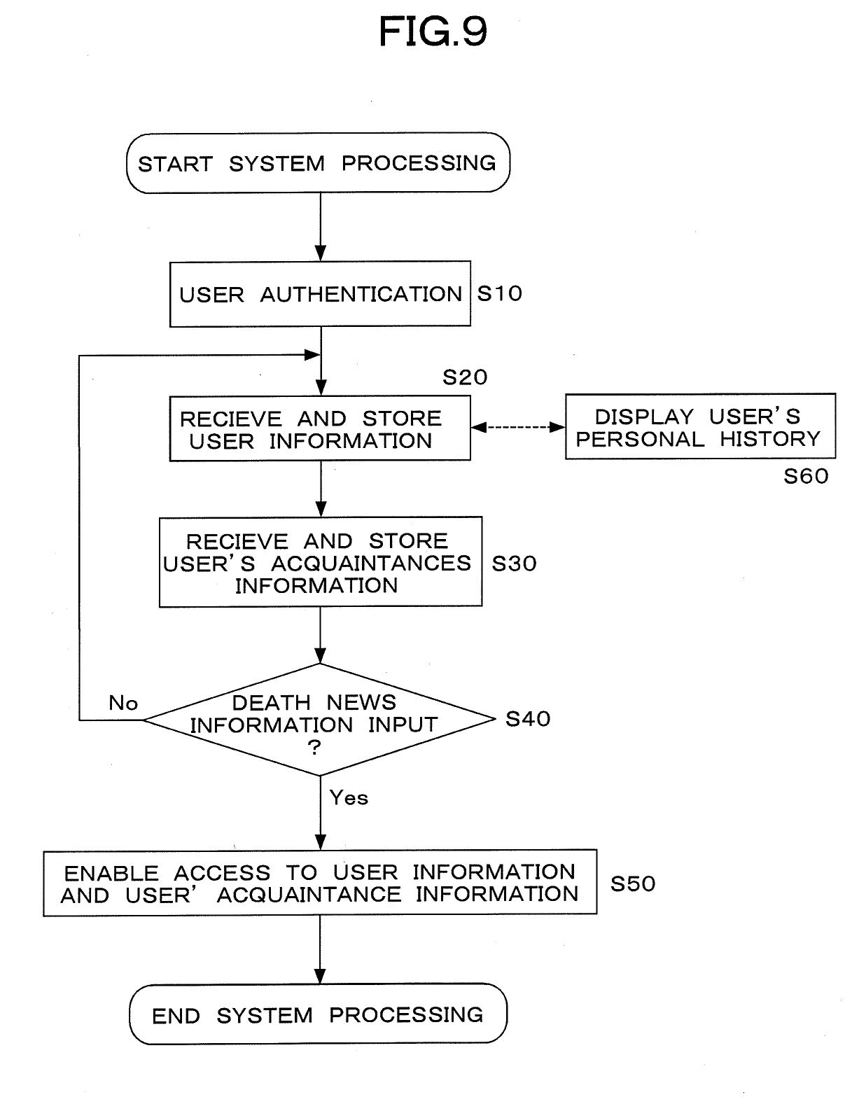

The flow of information processing performed by the personal information management system 100 according to this embodiment is described with reference to FIG. 9 and the like. FIG. 9 is a flowchart illustrating an example of the processing by the personal information management system 100.

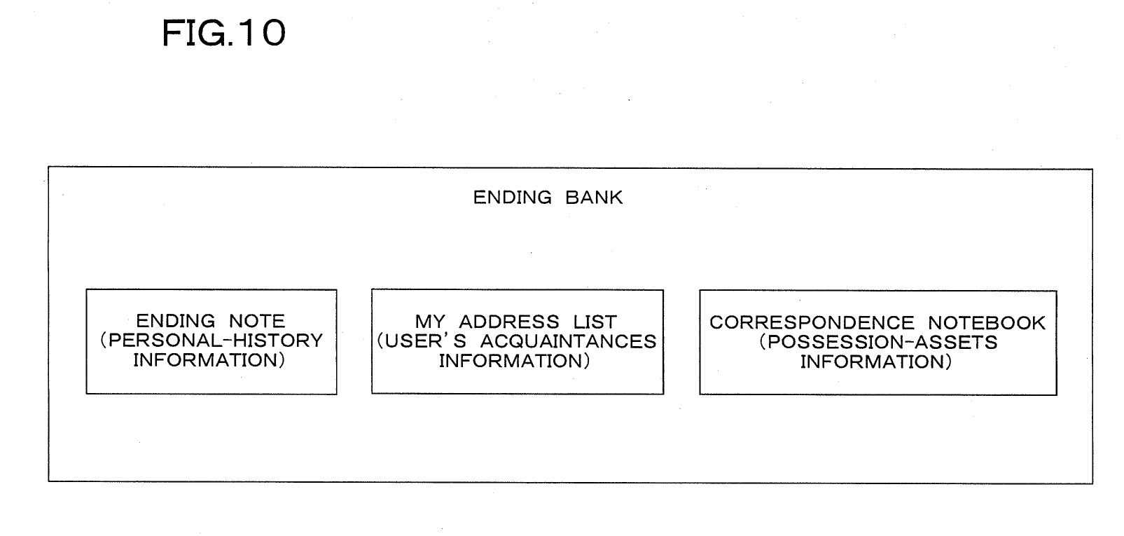

In S10, an authentication unit detects an access by the user via the user terminal 400 and the communications network 500 and then performs user authentication based on a user's right to use the personal information management system 100. Here, the user authentication is performed by typical user authentication processing. When the user authentication is properly performed in S10, the personal information management system 100 causes a screen as an entrance to services offered by the personal information management system 100 as illustrated in FIG. 10 to be displayed on the user terminal 400.

When the user selects “ending note (the personal-history information 200)” placed on the left side of the displayed screen illustrated in FIG. 10, the user-information reception unit 110 receives the input of the personal-history information 200 by the user via the user terminal 400 in S20. The user inputs information corresponding to the respective items illustrated in FIGS. 3 through 5 using the user terminal 400, and the user-information reception unit 110 receives the input of the information by the user together with item names corresponding to the respective input information.

When the user selects “correspondence notebook (the possession-assets information 210)” placed on the right side of the displayed screen illustrated in FIG. 10, the user-information reception unit 110 receives the input of the possession-assets information 210 by the user via the user terminal 400 in S20. The user inputs information corresponding to the respective items illustrated in FIG. 6 using the user terminal 400, and the user-information reception unit 110 receives the input of the information by the user together with item names corresponding to the respective input information.

Then, the user-information storage unit 120 stores the input of the information received by the user-information reception unit 110 so as to be related to the item names corresponding to the respective input information.

When the user selects “my address list (the user's acquaintances information 220)” placed on the central side of the displayed screen illustrated in FIG. 10, the user's-acquaintances-information reception unit 130 receives the input of the user's acquaintances information 220 by the user via the user terminal 400 in S30. The user inputs information corresponding to the respective items illustrated in FIG. 7 using the user terminal 400, and the user's-acquaintances-information reception unit 130 receives the input of the information by the user together with item names corresponding to the respective input information.

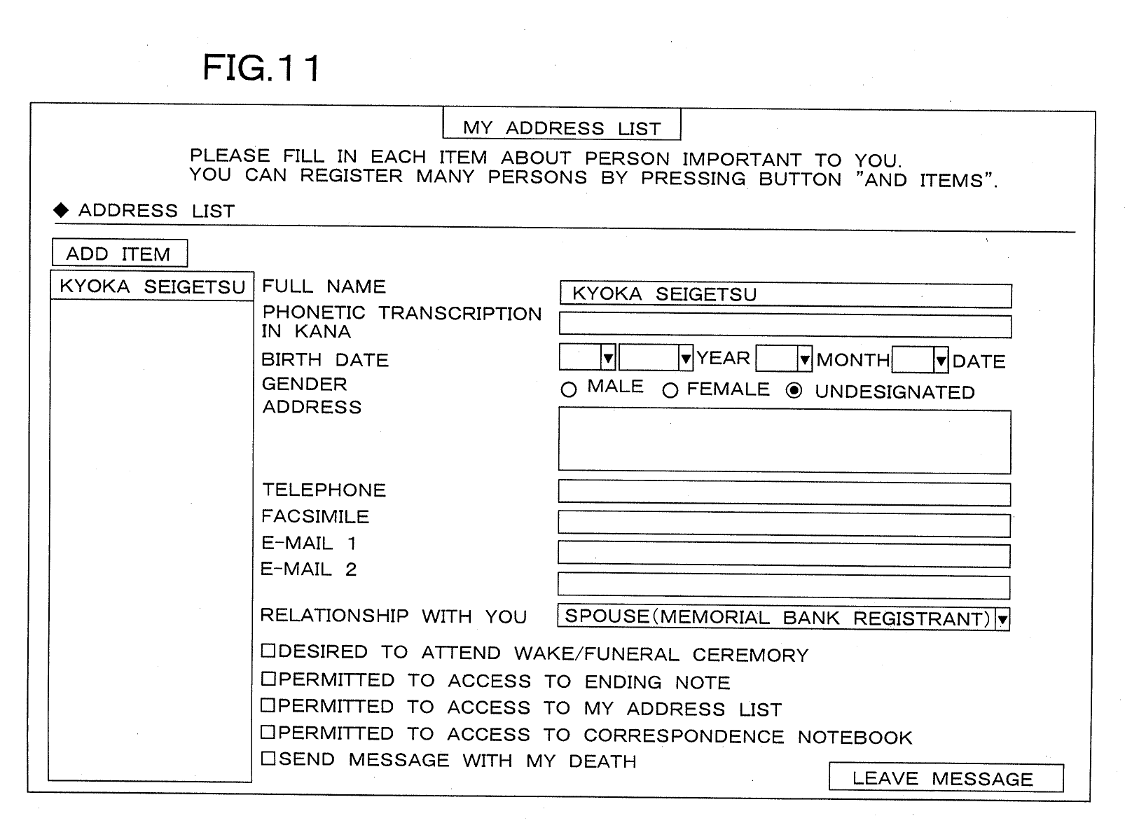

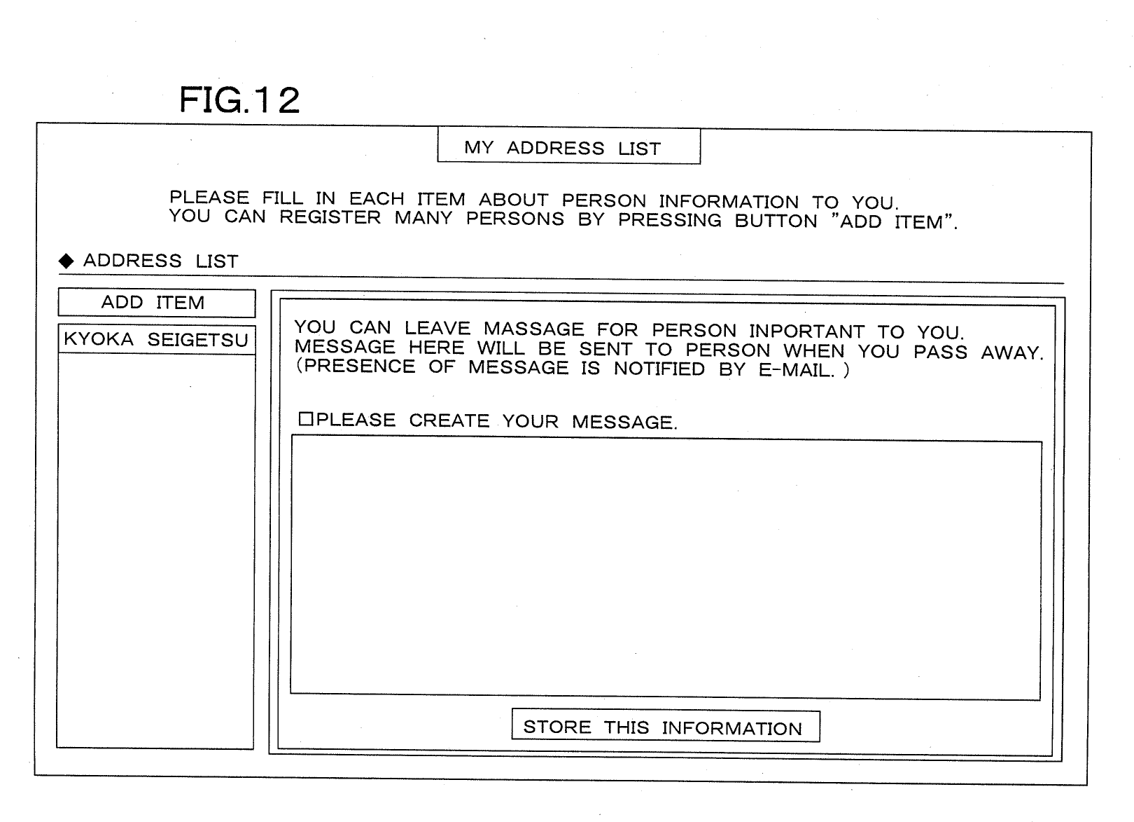

The user's-acquaintances-information reception unit 130 provides the user terminal 400 with an input screen as illustrated in, for example, FIG. 11 to receive an input by the user. In an example of the input screen illustrated in FIG. 11, the details of the disclosure permission information 230 and the message notification permission information 240 are input and defined in such a manner that respective check boxes at the central lower part of the screen are checked. Further, a check box related to the death-news-input permission information 250 may be provided in the input screen illustrated in FIG. 11 to receive an input by the user for defining the details of such information. Moreover, with respect to a message of the message notification permission information 240, an input screen as illustrated in FIG. 12 may be displayed on the user terminal 400 to receive the input of the message.

Then, in S30, the user's-acquaintances-information storage unit 140 stores the input of the information received by the user's-acquaintances-information reception unit 130 so as to be related to item names corresponding to the respective input information received by the user's-acquaintances-information reception unit 130.

In S40, the death news reception unit 150 determines according to the death-news-input permission information 250 whether the user who attempts to input death news information is equivalent to the user who is permitted to input the death news information when some user has passed away. Here, the determination of the user who is permitted to input the death news information is performed by typical user authentication processing.

Then, when it is determined according to the death-news-input permission information 250 that the user who attempts to input the death news information is equivalent to the user who is permitted to input the death news information, the death news reception unit 150 receives the input of the death news information as information indicating that the user has passed away in S40 (Yes in S40). Here, it is to be noted that the user who inputs the information in S10 and S20 is different from the user who inputs the information in S40.

In S50, the access enabling unit 160 enables each of relatives and acquaintances of the user to access to the user information 190 and the user's acquaintances information 220 according to the details of the disclosure permission information 230 input by the user (user who inputs the information in S10 and S20) as a person concerned with the death news information. In other words, the access enabling unit 160 determines according to the disclosure permission information 230 whether the user who wishes to access to the user information 190 and the user's acquaintances information 220 is equivalent to the user who is permitted to access to the user information 190 and the user's acquaintances information 220 when some user has passed away and then enables the user to access to the user information 190 and the user's acquaintances information 220 only where the user is determined to be the user who is permitted to access to the user information 190 and the user's acquaintances information 220. Here, the determination of the user who is permitted to access to the user information 190 and the user's acquaintances information 220 is performed by typical user authentication processing.

Further, in S50, the message information notification unit 170 notifies each of the relatives and the acquaintances of the user of a message according to the details of the message notification permission information 240 input by the user (user who inputs the information in S10 and S20) as a person concerned with the death news information. For example, the message information notification unit 170 sends a “message” input to the screen illustrated in FIG. 12 to an address written in the user's acquaintances information 220 by post or sends the message to an E-mail address written in the user's acquaintances information 220 by e-mail.

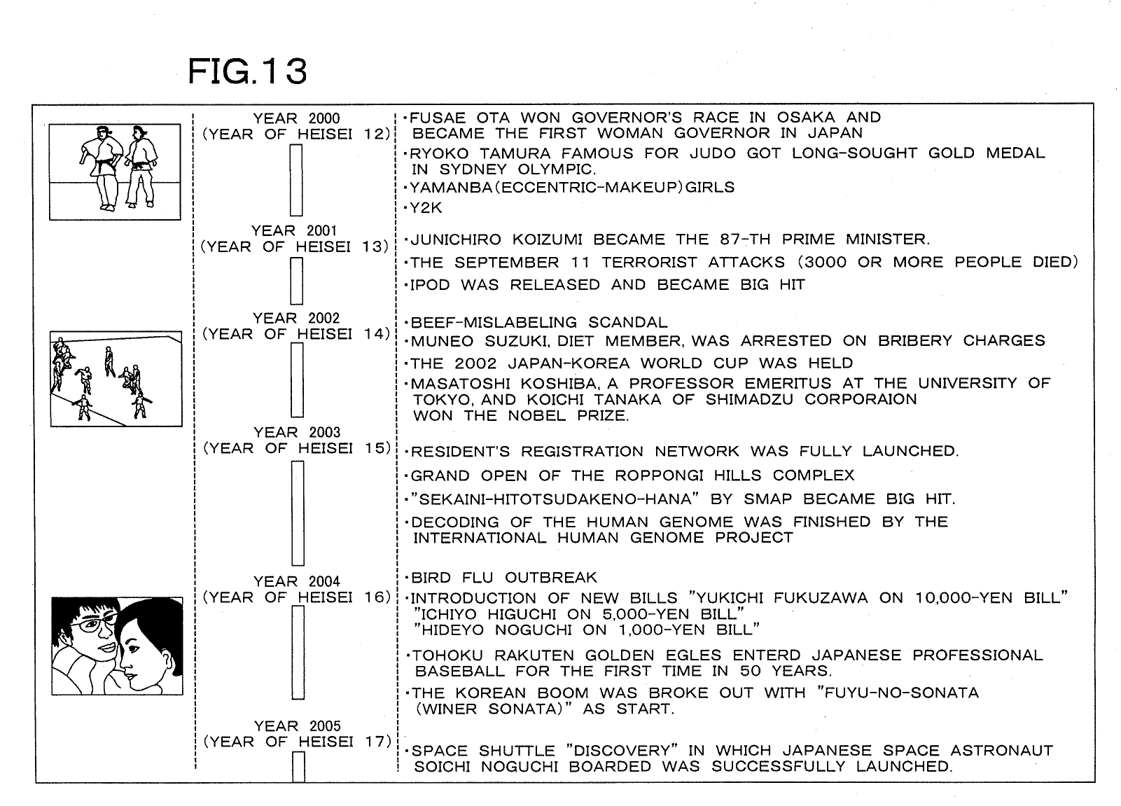

Moreover, in S60, in response to a request by the user, the personal-history display unit 180 causes a user's personal history to be displayed on the display unit of the user terminal 400 based on the user information 190 and the personal-history-related DB 260. As illustrated in, for example, FIG. 13, the personal-history display unit 180 causes years to be arranged at the central column of the display unit and causes the history information 270 and motion pictures specified by the URL information 280 to be chronologically displayed at the right column and the left column of the display unit, respectively, so as to correspond to the years.

In this manner, the personal information management system 100 enables the deceased to record information on himself or herself and information on relatives and acquaintances before his or her death and convey the information recorded by the deceased to persons within a desired limited range using his or her death as a trigger.

The present invention is not limited to the specifically disclosed embodiment, and variations and modifications may be made without departing from the scope of the present invention.

The present application is based on Japanese Priority Application No. 2011-028018 filed on Feb. 13, 2011, the entire contents of which are hereby incorporated herein by reference.

What is claimed is:

1. A personal information management system comprising:
a user-information reception unit configured to receive an input of user information by a user, the user information containing personal-history information as information on events related to the user and future action plans and containing possession-assets information as information on assets possessed by the user;
a user's-acquaintances-information reception unit configured to receive an input of user's acquaintances information by the user, the user's acquaintances information containing personal information on relatives and acquaintances of the user;
a death news reception unit configured to receive an input of death news information as information indicating that the user has passed away;
a user-information storage unit configured to store the user information received by the user-information reception unit; and
a user's-acquaintances-information storage unit configured to store the user's acquaintances information received by the user's-acquaintances-information reception unit; wherein
the user's acquaintances information contains disclosure permission information that defines for each of the relatives and the acquaintances of the user whether the user information stored in the user-information storage unit and/or the user's acquaintances information stored in the user's-acquaintances-information storage unit are/is disclosed when the user has passed away, and
the personal information management system further comprises an access enabling unit configured to enable, when the death news reception unit receives the death news information, the relatives and the acquaintances of the user to which the user information and/or the user's acquaintances information are/is defined by the disclosure permission information to be disclosed when the user has passed away to access to the user information stored in the user-information storage unit and/or the user's acquaintances information stored in the user's-acquaintances-information storage unit according to details defined in the disclosure permission information.

2. The personal information management system according to claim 1, wherein
the user's acquaintances information contains for each of the relatives and acquaintances of the user address information, message information from the user to each of the relatives and the acquaintances of the user, and message notification permission information that defines whether the message information is notified to the address information, and
the access enabling unit comprises a message information notification unit configured to notify, when the death news reception unit receives the death news, an address specified by the address information corresponding to each of the relatives and the acquaintances of the user the message information corresponding to each of the relatives and the acquaintance of the user with respect to each of the relatives and the acquaintances of the user who are defined by the message notification permission information to be notified of the message information.

3. The personal information management system according to claim 1, wherein
the disclosure permission information defines disclosure permission for each of the personal-history information, the possession-assets information, and the user's acquaintances information.

4. The personal information management system according to claim 1, wherein
the user's acquaintances information contains for each of the relatives and the acquaintances of the user information as to whether attendance at a wake and/or a funeral ceremony of the user is desired by the user.

5. The personal information management system according to claim 1, wherein
the user's acquaintances information contains for each of the relatives and the acquaintances of the user death-news-input permission information as information that defines permission for an input of the death news information, and
the death news reception unit receives the input of the death news information by a user determined to be one of the relatives and acquaintances of the user who are defined by the death-news-input permission information to be permitted to input the death news information.

6. The personal information management system according to claim 1, further comprising:
a personal-history-related database in which history information on past events and URL (Uniform Resource Locator) information on motion pictures corresponding to the past events and posted to an outside motion-pictures posting site are stored so as to be related to each other; and
a personal-history display unit configured to cause, when the personal-history information contains information on a birth date of the user, the history information on the past events and the motion pictures specified by the URL information stored corresponding to the history information on the past events to be chronologically displayed on a display unit based on the information stored in the personal-history-related database with a date going back to a certain period from the birth date set as a starting point.

7. A personal information management method of a personal information management system, the personal information management method comprising:
causing a user-information reception unit to receive an input of user information by a user, the user information containing personal-history information as information on events related to the user and future action plans and containing possession-assets information as information on assets possessed by the user;
causing a user's-acquaintances-information reception unit to receive an input of user's acquaintances information by the user, the user's acquaintances information containing personal information on relatives and acquaintances of the user; and
causing a death news reception unit to receive an input of death news information as information indicating that the user has passed away; wherein
the personal information management system comprises
a user-information storage unit configured to store the user information received by the user-information reception unit and
a user's-acquaintances-information storage unit configured to store the user's acquaintances information received by the user's-acquaintances-information reception unit; wherein
the user's acquaintances information contains disclosure permission information that defines for each of the relatives and the acquaintances of the user whether the user information stored in the user-information storage unit and/or the user's acquaintances information stored in the user's-acquaintances-information storage unit are/is disclosed when the user has passed away; and wherein
the personal information management method further comprises
causing an access enabling unit to enable, when the death news reception unit receives the death news information, the relatives and the acquaintances of the user to which the user information and/or the user's acquaintances information are/is defined by the disclosure permission information to be disclosed when the user has passed away to access to the user information stored in the user-information storage unit and/or the user's acquaintances information stored in the user's-acquaintances-information storage unit according to details defined in the disclosure permission information.

8. The personal information management method according to claim 7, wherein
the user's acquaintances information contains for each of the relatives and acquaintances of the user address information, message information from the user to each of the relatives and the acquaintances of the user, and message notification permission information that defines whether the message information is notified to the address information, and
the personal information management method further comprises causing a message information notification unit of the access enabling unit to notify, when the death news reception unit receives the death news, an address specified by the address information corresponding to each of the relatives and the acquaintances of the user the message information corresponding to each of the relatives and the acquaintance of the user with respect to each of the relatives and the acquaintances of the user who are defined by the message notification permission information to be notified of the message information.

9. The personal information management method according to claim 7, wherein
the disclosure permission information defines disclosure permission for each of the personal-history information, the possession-assets information, and the user's acquaintances information.

10. The personal information management method according to claim 7, wherein
the user's acquaintances information contains for each of the relatives and the acquaintances of the user information as to whether attendance at a wake and/or a funeral ceremony of the user is desired by the user.

11. The personal information management method according to claim 7, wherein
the user's acquaintances information contains for each of the relatives and the acquaintances of the user death-news-input permission information as information that defines permission for an input of the death news information, and
the death news reception unit receives the input of the death news information by a user determined to be one of the relatives and acquaintances of the user who are defined by the death-news-input permission information to be permitted to input the death news information.

12. The personal information management method according to claim 7, wherein
the personal information management system further comprises
a personal-history-related database in which history information on past events and URL (Uniform Resource Locator) information on motion pictures corresponding to the past events and posted to an outside motion-pictures posting site are stored so as to be related to each other, and
the personal information management method further comprises
causing, when the personal-history information contains the information on a birth date of the user, a personal-history display unit to chronologically display on a display unit the history information on the past events and the motion pictures specified by the URL information stored corresponding to the history information on the past events based on the information stored in the personal-history-related database with a date going back to a certain period from the birth date set as a starting point.

13. A recording medium having recorded therein a personal information management program configured to cause a computer to execute the method according to claim 7.
